(19) United States
(12) Patent Application Publication
(10) Pub. No.: US 2023/0372888 A1
(43) Pub. Date: Nov. 23, 2023

(54) SYSTEMS AND METHODS FOR PRODUCTION OF ALUMINUM CHLOROHYDRATES

(71) Applicants: Mark Hulsizer, Fort Worth, TX (US); BOARD OF REGENTS, THE UNIVERSITY OF TEXAS SYSTEM, Austin, TX (US)

(72) Inventors: Frederick M. MacDonnell, Arlington, TX (US); Brian Dennis, Arlington, TX (US); Mark Hulsizer, Fort Worth, TX (US)

(21) Appl. No.: 18/313,635

(22) Filed: May 8, 2023

Related U.S. Application Data
(60) Provisional application No. 63/343,267, filed on May 18, 2022.

(51) Int. Cl. B01J 8/02; C01F 7/786

(52) U.S. Cl. CPC B01J 8/0278; B01J 8/0292; C01F 7/786; B01J 2208/00884

(57) ABSTRACT

Disclosed herein are systems for more efficient production of aluminum chlorohydrates, where the systems comprise a support element and/or metal catalyst, where the support element is configured to support the metal reagent in the system. Methods for efficient production of aluminum chlorohydrates are also disclosed.

### CROSS-REFERENCE TO RELATED APPLICATIONS

This application claims the benefit of U.S. Provisional Application No. 63/343,267, filed May 18, 2022, the content of which is incorporated herein by reference in its entirety.

TECHNICAL FIELD

The present invention generally relates to systems and methods for producing an aluminum chlorohydrate solution with high conversion efficiency and yield and low turbidity.

### BACKGROUND

Aluminum chlorohydrate (ACH) is a highly water-soluble aluminum complex with the general formula AlₙCl₍₃ₙ₋ₘ₎(OH)ₘ that needs to meet certain specifications in specific gravity, pH, basicity, turbidity, and Al content when produced. Depending on the desired application, the specific gravity of ACH typically ranges from 1.33 to 1.36, the pH from 3 to 4 (upon dilution 1:50 in water), and aluminum to chloride ratio of 1.9 to 2.1 aluminum to 1 chloride (mole ratio). Low turbidity is often an important specification, with acceptable turbidities being defined as below 50 NTUs.

ACH has a wide variety of applications, including drinking water treatment, sewage and industrial wastewater treatment, and paper and cosmetics manufacturing.

An industrial process of producing aluminum chlorohydrate (ACH) generally includes reacting the aluminum metal with aqueous acids, such as hydrochloric acid, as shown in the equation (Eq. 1):

2Al(s)+HCl (aq)+5 H₂O (l)→Al₂(OH)₅Cl(aq)+3H₂(g) Eq. (1)

However, currently, to produce ACH at scale, large amounts of aluminum ingots are required, and the process can take anywhere between 70 to 120 hours to complete, depending on the scale and reaction conditions.

Accordingly, a need exists for systems and methods for more efficient production of ACH. These needs and other needs are at least partially satisfied by the present disclosure.

### SUMMARY

The present invention is directed to a system comprising a) a reactor tank configured to receive a fluid reagent and comprising: a support element configured to support a metal reagent disposed as a metal reagent bed; wherein the support element is further configured to allow the fluid reagent to substantially wet at least a portion of the metal reagent; and b) a metal catalyst.

In still further aspects, the support element of the disclosed system can be further configured to partition at least one portion of the metal reagent from a remaining portion of the metal reagent. In alternative or additional aspects, the support element can be further configured to immobilize at least one portion of the metal reagent in a predetermined space, wherein the predetermined space is defined by a support element pattern.

In some aspects, the metal reagent can comprise aluminum metal pellets. Yet, in other aspects, the fluid reagent can comprise an aqueous hydrochloric acid. In still further aspects, when both the metal reagent and the fluid reagent are present in the system, the metal catalyst can catalyze the reaction between the metal reagent and the fluid reagent, where a reaction product comprises aluminum chlorohydrate.

In still further aspects, the systems disclosed herein comprise the metal catalyst having a redox potential effective to induce oxidation of the metal reagent.

Also disclosed herein are aspects directed to a system comprising: a) a reactor tank configured to receive a fluid reagent and comprising: a support element configured to support a metal reagent disposed as a metal reagent bed, wherein the support element is configured to immobilize at least one portion of the metal reagent in a predetermined space, wherein the predetermined space is defined by a support element pattern, and wherein the support element is further configured to allow the fluid reagent to substantially wet at least a portion of the metal reagent.

Also disclosed herein are methods comprising: contacting an aluminum feedstock with a fluid reagent comprising hydrochloric acid to form an aluminum chlorohydrate solution in the presence of a metal catalyst, wherein the metal catalyst is in substantial contact and electrical communication with at least a portion of the aluminum feedstock; wherein the step of contacting is in a reactor tank comprising a support element configured to support the aluminum feedstock disposed as an aluminum bed, wherein the support element is positioned such that the fluid reagent is configured to wet substantially all or at least a substantial portion of the aluminum bed.

In certain aspects, also disclosed are methods comprising: contacting an aluminum feedstock with a fluid reagent comprising hydrochloric acid to form an aluminum chlorohydrate solution; wherein the step of contacting is in a reactor tank comprising a support element configured to support the aluminum feedstock disposed as an aluminum bed, wherein the support element is configured to immobilize at least one portion of the aluminum feedstock in a predetermined space, wherein the predetermined space is defined by a support element pattern, and wherein the support element is positioned such that the fluid reagent is configured to wet substantially all or at least a substantial portion of the aluminum bed.

Additional aspects of the disclosure will be set forth, in part, in the detailed description, figures, and claims which follow, and in part will be derived from the detailed description or can be learned by practice of the invention. It is to be understood that both the foregoing general description and the following detailed description are exemplary and explanatory only and are not restrictive of the invention as disclosed.

### BRIEF DESCRIPTION OF DRAWINGS

FIG. 1 illustrates a top-down view into a 12,000-gallon reactor after a reaction of 200% charge of aluminum pellets (⅜ inch). The arrows show points of particular interest: a) a 3 ft standpipe nearly buried in Al pellets due to the piling effect, b) three standpipes with almost no pellet bed, c) bare floor (top of the false floor) with no pellets present.

FIGS. 2A-2F depict photographs of exemplary support elements in various aspects of the disclosure. FIG. 2A shows a small-scale model of an exemplary support element having a 3D pipe grid configuration and comprising CPVC pipes without apertures; FIG. 2B shows a small-scale model of an exemplary support element having a 3D pipe grid configuration and comprising CPVC pipes with a plurality of apertures within the support element and an exemplary metal catalyst present in the system; FIG. 2C shows an exemplary metal catalyst form in a 50 gal tank reactor; FIG. 2D shows an exemplary metal catalyst form holding Al pellets having an average size of ⅜″; FIG. 2E shows an exemplary metal catalyst form after a large-scale run with bones and FIG. 2F shows a CPVC support element with a plurality of apertures and an additional exemplary supporting polypropylene netting.

FIG. 3 depicts a small-scale model of an exemplary support element having a “star” pipe configuration and a metal catalyst in the form of a copper screen before (top), after an ACH run (middle), and after removal and water rinsing (bottom).

FIGS. 4A-4D depict exemplary configurations of the support element in some aspects.

FIG. 5 depicts exemplary support element modules.

FIGS. 6A-6D depict exemplary module configurations for circular tanks with different diameters.

FIGS. 7A-7D depicts exemplary module configurations for support elements in some aspects.

### DETAILED DESCRIPTION

The present invention can be understood more readily by reference to the following detailed description, examples, drawings, and claims, and their previous and following description. However, before the present articles, systems, and/or methods are disclosed and described, it is to be understood that this invention is not limited to the specific or exemplary aspects of articles, systems, and/or methods disclosed unless otherwise specified, as such can, of course, vary. It is also to be understood that the terminology used herein is for the purpose of describing particular aspects only and is not intended to be limiting.

The following description of the invention is provided as an enabling teaching of the invention in its best, currently known aspect. To this end, those skilled in the relevant art will recognize and appreciate that many changes can be made to the various aspects of the invention described herein while still obtaining the beneficial results of the present invention. It will also be apparent that some of the desired benefits of the present invention can be obtained by selecting some of the features of the present invention without utilizing other features. Accordingly, those of ordinary skill in the pertinent art will recognize that many modifications and adaptations to the present invention are possible and may even be desirable in certain circumstances and are a part of the present invention. Thus, the following description is again provided as illustrative of the principles of the present invention and not in limitation thereof.

### Definitions

As used herein, the singular forms “a,” “an,” and “the” include plural referents unless the context clearly dictates otherwise. Thus, for example, reference to a “support element” includes aspects having two or more such support elements unless the context clearly indicates otherwise.

It is appreciated that certain features of the disclosure, which are, for clarity, described in the context of separate aspects, can also be provided in combination in a single aspect. Conversely, various features of the disclosure, which are, for brevity, described in the context of a single aspect, can also be provided separately or in any suitable subcombination.

As used herein, the terms “optional” or “optionally” mean that the subsequently described event or circumstance may or may not occur, and that the description includes instances where said event or circumstance occurs and instances where it does not.

It is also to be understood that the terminology used herein is for the purpose of describing particular aspects only and is not intended to be limiting. As used in the specification and in the claims, the term “comprising” can include the aspects “consisting of” and “consisting essentially of.” Unless defined otherwise, all technical and scientific terms used herein have the same meaning as commonly understood by one of ordinary skill in the art to which this invention belongs. In this specification and in the claims which follow, reference will be made to a number of terms that shall be defined herein.

For the terms “for example” and “such as” and grammatical equivalences thereof, the phrase “and without limitation” is understood to follow unless explicitly stated otherwise.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the standard deviation found in their respective testing measurements. Furthermore, when numerical ranges of varying scope are set forth herein, it is contemplated that any combination of these values, inclusive of the recited values, may be used. Further, ranges can be expressed herein as from “about” one particular value and/or to “about” another particular value. When such a range is expressed, another aspect includes from the one particular value and/or to the other particular value.

Similarly, when values are expressed as approximations, by use of the antecedent “about,” it will be understood that the particular value forms another aspect. It will be further understood that the endpoints of each of the ranges are significant both in relation to the other endpoint and independently of the other endpoint. Unless stated otherwise, the term “about” means within 5% (e.g., within 2% or 1%) of the particular value modified by the term “about.”

Throughout this disclosure, various aspects of the invention can be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, a description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6 and any whole and partial increments therebetween. This applies regardless of the breadth of the range.

A weight percent (wt. %) of a component, unless specifically stated to the contrary, is based on the total weight of the formulation or composition in which the component is included.

It will be understood that when an element is referred to as being “connected” or “coupled” to another element, it can be directly connected or coupled to the other element, or intervening elements may be present. In contrast, when an element is referred to as being “directly connected” or “directly coupled” to another element, there are no intervening elements present. Other words used to describe the relationship between elements or layers should be interpreted in a like fashion (e.g., “between” versus “directly between,” “adjacent” versus “directly adjacent,” “on” versus “directly on”).

As used herein, the term “and/or” includes any and all combinations of one or more of the associated listed items.

It will be understood that although the terms “first,” “second,” etc., may be used herein to describe various elements, components, regions, layers, and/or sections. These elements, components, regions, layers, and/or sections should not be limited by these terms. These terms are only used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations), and the spatially relative descriptors used herein are interpreted accordingly.

As used herein, the term “substantially” means that the subsequently described event or circumstance completely occurs or that the subsequently described event or circumstance generally, typically, or approximately occurs.

Still further, the term “substantially” can, in some aspects, refer to at least about 80%, at least about 85%, at least about 90%, at least about 91%, at least about 92%, at least about 93%, at least about 94%, at least about 95%, at least about 96%, at least about 97%, at least about 98%, at least about 99%, or about 100% of the stated property, component, composition, or other condition for which substantially is used to characterize or otherwise quantify an amount.

In other aspects, as used herein, the term “substantially free,” when used in the context of a composition or component of a composition that is substantially absent, is intended to indicate that the recited component is not intentionally batched and added to the composition but can be present as an impurity along with other components being added to the composition. In such aspects, the term “substantially free” is intended to refer to trace amounts that can be present in the batched components, for example, it can be present in an amount that is less than about 1 by weight, e.g., less than about 0.5% by weight, less than about 0.1% by weight, less than about 0.05% by weight, or less than about 0.01% by weight of the stated material, based on the total weight of the composition.

As used herein, the term “substantially,” in, for example, the context “substantially identical” or “substantially similar,” refers to a method or a system, or a component that is at least about 90%, at least about 91%, at least about 92%, at least about 93%, at least about 94%, at least about 95%, at least about 96%, at least about 97%, at least about 98%, at least about 99%, or about 100% by similar to the method, system, or the component it is compared to.

As used herein, the terms “substantially identical reference composition” and “substantially identical reference article” refer to a reference system or method comprising substantially identical components or method steps in the absence of an inventive component. In another exemplary aspect, the term “substantially,” in, for example, the context “substantially identical reference system” or “substantially identical reference method,” refers to a reference device or a method comprising substantially identical components and wherein an inventive component is absent or is substituted with a common in the art component.

While aspects of the present invention can be described and claimed in a particular statutory class, such as the system statutory class, this is for convenience only and one of ordinary skill in the art will understand that each aspect of the present invention can be described and claimed in any statutory class. Unless otherwise expressly stated, it is in no way intended that any method or aspect set forth herein be construed as requiring that its steps be performed in a specific order. Accordingly, where a method claim does not specifically state in the claims or descriptions that the steps are to be limited to a specific order, it is in no way intended that an order be inferred in any respect. This holds for any possible non-express basis for interpretation, including matters of logic with respect to the arrangement of steps or operational flow, plain meaning derived from grammatical organization or punctuation, or the number or type of aspects described in the specification.

The present invention may be understood more readily by reference to the following detailed description of various aspects of the invention and the examples included therein and to the Figures and their previous and following description.

### Systems

As disclosed above, the conventional production of ACH is based on a reaction between aluminum ingots and hydrochloric acid. While not intending to be bound by theory, it is believed the reaction occurs when an acid encounters the surface area of the aluminum metal. The conventional methods of making the ACH have a very slow rate and therefore have many drawbacks, such as a prolonged reaction time in harsh acidic conditions that can be hazardous to the environment and the operating personnel.

The rate of the reaction is dictated by the aluminum metal surface area, where increasing the surface area correspondingly increases the rate of the reaction. In some aspects, to increase the reaction rate, excess of the aluminum ingot can be added, thereby adding additional surface area and decreasing the time needed to complete the reaction. For example, if 100% represents the aluminum charge (in mass) needed to complete the reaction stoichiometrically, typical operating procedures use charges of about 200% to about 500% of the stoichiometric amount of aluminum needed to speed up the process, with greater excesses leading to shorter reaction times. However, such processes are undesirable due to the large amounts of metal needed to be charged in the system.

In certain aspects, to improve the reaction speed, smaller aluminum pieces (feedstock) can be utilized. In such aspects, it is understood that the surface area per mass unit can be increased. Small Form Aluminum Metal (SFAM), defined as pellets smaller than about 125 mm and larger than about 1 mm, or in some cases, between about ¼ to about ⅜ inches in diameter, provides large surface areas per unit mass compared to ingot. For example, SFAM pellets with a diameter of about ⅜ inch have about 28 times more surface area than an equivalent weight of about 50 lbs. ingots.

Without wishing to be bound by any theory, it is suggested that the reaction rate for SFAM pellets can be faster than the rate for the larger ingots. Use of SFAM pellets can have additional safety benefits. For example, SFAM pellets can be loaded into the reactor tank without operating personal performing a confined space entry, decreasing both the batch preparation time and danger to the operator. ACH production runs, in which about 6,000 lb. of Al pellets (about ⅜ inch diameter) are consumed, can be completed in about 24 h if an about 200% pellet charge is used (e.g., about 12,000 lb. starting charge).

However, it is understood that the use of SFAM has its own drawbacks, as this feedstock is observed to frequently lead to ACH with unacceptably high turbidities. For example, if the pellets have a high packing density, less acid solution can circulate between pellets. During the exothermic reaction, this can lead to the development of ‘hot spots’ in which the hydration of the pellet bed is insufficient, and some of the ACH is dried out and forms an insoluble hydrated aluminum oxide, which causes catastrophic increases in turbidity.

These issues of insufficient hydration and high turbidity need to be resolved in order to obtain commercially scalable and industry-acceptable ACH production.

WO2019/16938, the content of which is incorporated herein in its whole entirety by reference, discloses the use of a false floor in which the aqueous acid solution flows through standpipes from above the pellet bed to space beneath the pellet bed and then upwards through the pellet bed through a multitude of small holes in the false floor. However, such a solution still requires about 200% Al pellet charge to have a run time of about 24 h.

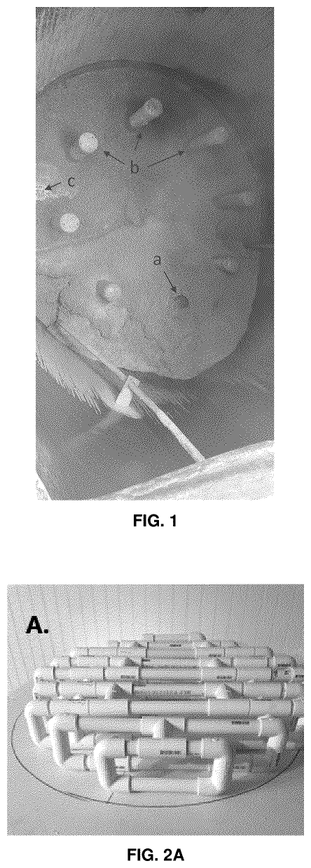

Additional issues with the ACH production are the appearance of pilling. The aluminum pellets are light enough that during the dissolution reaction, a significant portion of the pellets is fluidized and tends to settle in one area over another, leading to an uneven pellet bed thickness. For example, FIG. 1 shows an about 12,000-gallon ACH tank reactor (with pellet bones present) fitted with a false floor and 8 standpipes through which acid solution above the bed is drawn down underneath the pile. After a pellet reaction (about 200% charge), the drained tank reveals the piling of the pellet bed up to about 36 inches deep (FIG. 1. Point a) in some places, and the reactor floor is uncovered on the other side (FIG. 1. Point c). It is understood that the pilling phenomena can be observed when aluminum pellets are used as feedstock material in the reactors with or without the false floor present. As one of ordinary skill in the art would readily appreciate, the pilling phenomena can result in a thicker pellet bed that is harder to fully hydrate, leading to increases in turbidity.

The present disclosure overcomes these issues. In one aspect, disclosed herein is a system comprising a) a reactor tank configured to receive a fluid reagent and comprising: a support element configured to support a metal reagent disposed as a metal reagent bed; wherein the support element is further configured to allow the fluid reagent to substantially wet at least a portion of the metal reagent; and b) a metal catalyst.

It is understood that the support element present in the system can support the metal reagent in any desired way. It is further understood that in such exemplary aspects, the support element, for example, is capable of holding or immobilizing the metal reagent from being uncontrollably moved or dispersed within the reactor. For example, in some aspects, the support element is configured to partition at least one portion of the metal reagent from the remaining portion of the metal reagent. In yet still further aspects, the support element can be further configured to immobilize at least one portion of the metal reagent in a predetermined space, wherein the predetermined space is defined by a support element pattern. In such exemplary aspects, the support element is capable of keeping the metal reagent in the predetermined space.

In certain aspects, at least a portion of the support element can be inseparably coupled to at least a portion of the reactor tank. In such exemplary and unlimiting aspects, the support element can be permanently attached to the reactor tank. However, here are also described aspects where the support element is separately coupled with at least a portion of the reactor tank. In such aspects, the coupling can be done by any known in the art fasteners suitable for the desired application and capable of withstanding the conditions needed to achieve the desired result. In such aspects, the support element can be separated from the reactor tank for cleaning or any other purpose if needed. Also disclosed herein are aspects where the support element is not physically coupled to the reactor tank. In such aspects, the support element can be removed from the tank for any reason without a need to separate it from the tank.

The system disclosed herein can also comprise the metal reagent added to the reactor tank. The system also can comprise the fluid reagent. In some aspects, the fluid reagent is in fluid communication with substantially all or at least a substantial portion of the metal reagent bed.

In some aspects, the metal reagent can comprise aluminum metal pellets. In other aspects, the fluid reagent comprises an aqueous hydrochloric acid. In still further aspects, a reaction product between the metal reagent and the fluid reagent comprises aluminum chlorohydrate.

In still further aspects, the metal reagent or a feedstock can comprise a large form of aluminum metal, often in the form of aluminum ingots. Alternatively, or in addition, the aluminum feedstock can comprise aluminum pellets and/or aluminum powder. The aluminum metal reagent can have any desired impurity levels. In certain aspects, the impurities present in aluminum metal reagents can comprise one or more of silicon, iron, zinc, gallium, vanadium, and/or other trace elements. The grade of aluminum metal reagent or feedstock employed in the systems and methods described herein can be determined according to several considerations, for example, the desired purity of the polyalumnium chloride to be produced and/or the end-use of the polyaluminum chloride. Notably, systems and methods described herein can increase reaction rates of polyaluminum chloride formation irrespective of the specific purity of the aluminum metal reagent when compared with substantially identical reference systems and methods without the presence of the support element and/or metal catalyst disclosed herein. In certain aspects, however, it is understood that an increase in reaction rates can vary according to the specific identity of the aluminum metal reagent. For example, higher purity aluminum grades can provide for a higher reaction rate when used in the disclosed herein systems. In some aspects, the aluminum metal reagent can comprise aluminum grades P0303, P0404, P0610, PI 015, PI 020, super high purity aluminum (4N and SN), or any combination thereof.

In still further aspects, the fluid reagent such as hydrochloric acid can be present in any concentration suitable to obtain the reaction product having desired characteristics. In some aspects, the hydrochloric acid can have a concentration of about 10 M, about 9 M, about 8 M, about 7 M, about 6 M, about 5 M, about 4 M, about 3 M, about 2 M, about 1 M, about 0.5 M, or about 0.1 M, wherein any of the stated values can form an upper or lower endpoint of a range.

In still further aspects, the metal reagent and the fluid reagents are present in a ratio from about 2:1 to about 10:1, including exemplary values of about 3:1, about 4:1, about 5:1, about 6:1, about 7:1, about 8:1, and about 9:1, wherein any of the stated values can form an upper or lower endpoint of a range. It is understood that in some aspects, the metal reagent can be present in the reaction mixture in stoichiometric excess. The addition of a stoichiometric excess of aluminum is one effective way in which to speed up the batch process time, but leftover, unreacted aluminum, commonly referred to as bones, can have associated issues. Systems and methods described herein can reduce stoichiometric excesses of aluminum while increasing reaction rates and lowering aluminum polychloride production times relative to conventional HCl treatment methods.

In still further aspects, the metal catalyst present in the system can comprise a metal net, wool, a screen, immobilized nanoparticles, a foam, or any combination thereof. It is understood that in the aspects where nanoparticles are used, these nanoparticles are in immobilized configuration and can be easily removed at the end of the process if needed without any additional steps such as filtration or collection of the nanoparticles from the reaction product.

In still further aspects, any known in the art metal catalysts that are suitable for the desired purpose can be utilized. In some exemplary aspects, the metal catalyst is chosen from a variety of metals having a redox potential effective to induce oxidation of the metal reagent. In some aspects, any metal catalyst capable of catalyzing oxidation of the disclosed herein reagents can be utilized. Without wishing to be bound by any theory, it is suggested that any metal catalyst having a redox potential more positive than a redox potential of the metal reagent can be utilized. For example, in some aspects, the metal catalyst can comprise iron, nickel, zinc, silver, cobalt, copper, palladium, ruthenium, iridium, platinum, gold, alloys thereof, or any combination thereof. It is understood, however, that the choice of the metal catalyst can also be defined by the desired application and economic benefits of utilizing such catalysts.

Without wishing to be bound by any theory, it is suggested that to achieve the desired enhanced reaction rate between the metal reagent and the fluid reagent, the metal catalyst needs to be in at least some physical contact with the metal reagent. In yet further aspects, the metal catalyst is in substantial contact and electrical communication with at least a portion of the metal reagent bed. Also disclosed herein are aspects where at least a portion of the metal catalyst is in substantial contact with at least a portion of the support element.

Without wishing to be bound by any theory, it is hypothesized that the extent of catalysis is proportional to a surface area of the metal catalyst and the amount of catalyst in close contact with the aluminum feedstock. While not intending to be bound by theory, it is believed the metal surface enhances to rate of hydrogen evolution over the non-catalyzed reaction, and the electrochemical contact of the aluminum with the catalyst allows H₂ evolution to occur on the metal catalyst surface with the accompanying anodic aluminum dissolution reaction occurring in the nearby aluminum pile. As positive Al³⁺ ions are generated at the anode (aluminum metal reagent behaves as an anode) and H⁺ ions consumed at the cathode (the metal catalyst behaves as a cathode in these exemplary aspects), the closer the cathode is to the anode, the faster the diffusion of the charge compensating ions occur, thus lowering the internal resistance of the electrochemical cell and the faster the electrochemical reactions at the anode and cathode occurs (Eq. 2 and 3).

2Al (s)→2Al³⁺(aq)+6e−ANODE (Eq. 2)

6e⁻+6H⁺(aq)→3H₂(g) CATHODE (Eq. 3)

It is further understood that the enhancement in the reaction rate can be dependent on the redox potential of the metal catalyst. In certain aspects, it is understood that the lower the overpotential for hydrogen evolution is, the higher is the reaction rate between the metal reagent and the fluid reagent.

The systems disclosed herein are designed in configurations that maximize the amount of metal reagent that is in direct contact with the metal catalyst. In some aspects, the support elements can be designed such that the metal catalyst can be positioned at the bottom of the reactor so as to trap the pellet in defined cavities, partitions, or areas. In the disclosed herein systems and as described above, the metal catalyst design not only maximizes the metal reagent/metal catalyst contact area, but it also immobilizes the pellet bed, preventing piling and large-scale movement of the pellets.

It is understood that the enhanced reaction rate obtained by the systems and methods disclosed herein allows for decreasing the stoichiometric excess of the metal reagent relative to the fluid reagent while providing for high yield and reduced reaction time. In some aspects, the metal reagent is present in an amount at least about 20% lower, at least about 25% lower, at least about 30% lower, at least about 35% lower, at least about 40% lower, at least about 45% lower, or even at least about 50% lower when compared to a substantially identical reference system in the absence of the metal catalyst and the support element while forming the reaction product with a yield substantially identical to the substantially identical reference system in the absence of the metal catalyst and the support element.

In still further aspects, the reaction product yield is greater than about 85%, greater than about 88%, greater than about 90%, greater than about 92%, greater than about 95%, greater than about 97%, or even greater than about 99.5%.

In still further aspects, the reaction yield as disclosed herein can be obtained in a time period that at least about 30, at least about 40%, at least about 50%, at least about 60%, at least about 70%, at least about 80%, at least about 90%, at least about 100% shorter than a time needed to achieve a substantially identical yield in the substantially identical reference system in the absence of the metal catalyst and the support element. Yet, in still further aspects, the same reaction yield that is being obtained in the substantially identical reference system in the absence of the metal catalyst and the support element can be achieved at least about 2 times faster, at least about 3 times faster, at least about 4 times faster, at least about 5 faster, or even about 6 times faster.

It is understood that since the systems and methods disclosed herein allow for the reduction of the amount of metal reagent used in the process while obtaining a high yield and reaction rate, it is also possible to reduce the waste formation and to improve the safety and sustainability of the process. The systems and methods disclosed herein also substantially minimize the need for reactor cleaning processes that is essential in the conventional systems and processes.

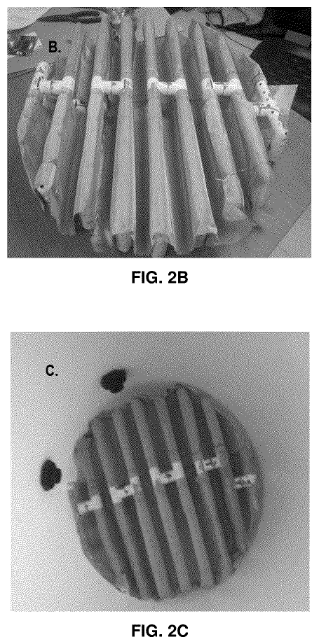

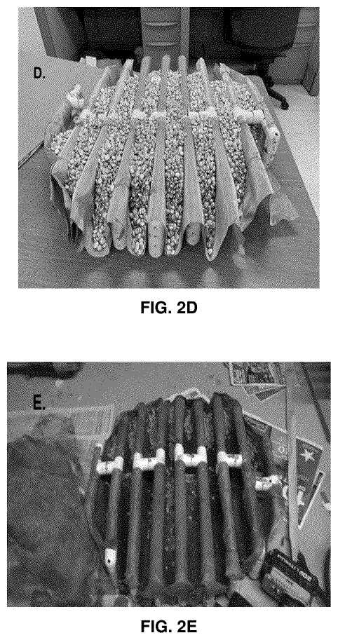

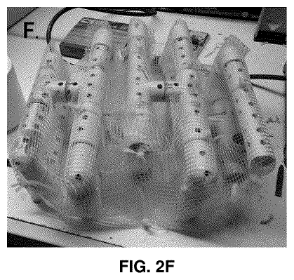

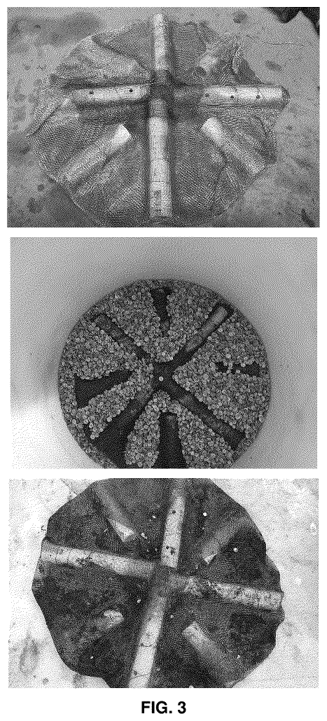

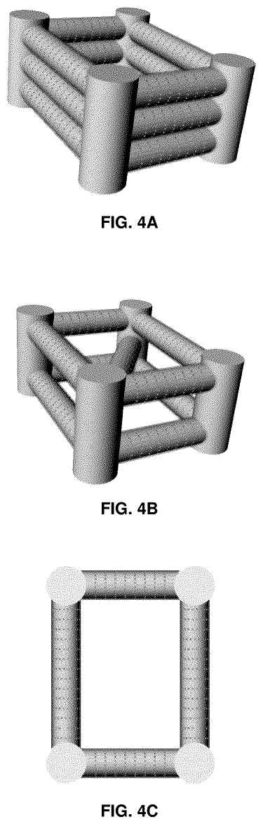

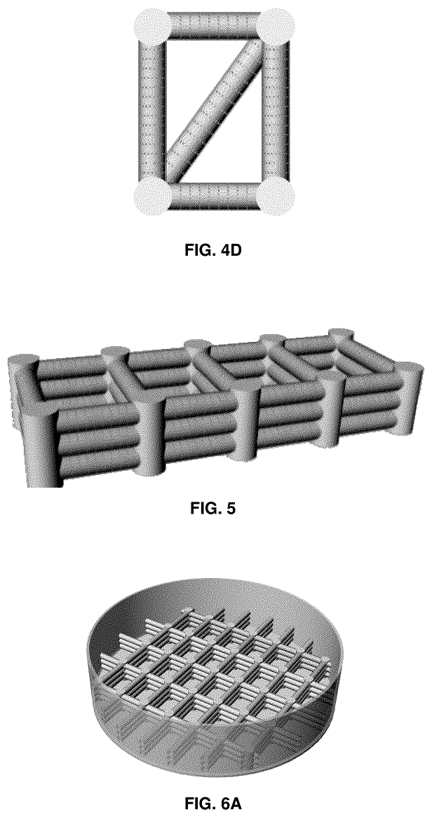

In still further aspects, it is understood that the support element can have any pattern that would achieve the desired result. Some exemplary patterns of the support element are shown in FIGS. 2A-7D. In certain aspects, the support element can comprise a plurality of members forming the desired pattern. For example, as shown in FIG. 2A, the support element can comprise a system of interlocked pipes forming the desired grid. The support element is shown in FIGS. 2B-2D comprises a plurality of members, such as, for example, pipes that are arranged in the waffle pattern. FIG. 3 shows a plurality of members of the support element arranged in a star pattern. Additional configurations and patterns that the plurality of members can be arranged into are also shown in FIGS. 4A-7D. For example, the plurality of members can be arranged into a plurality of modules configured to form one or more of the support element patterns.

In still further aspects, the support element pattern is chosen that it is effective to reduce a height of the metal reagent bed and to decrease the turbidity of the reaction product when compared to a substantially identical reference system in the absence of the support element and the metal catalyst. In such exemplary aspects, the metal reagent bed can have a height from at least about 10%, at least about 20%, at least about 30%, at least about 40%, or at least about 50% lower when compared to a height of a metal reagent bed of a substantially identical reference system in the absence of the metal catalyst and the support element.

The interlock between the plurality of members can be present in various positions, thereby defining one or more spaces of the predetermined volume where a portion of the metal reagent can be immobilized and at least partially separated for a reminding portion of the metal reagent. Such separations of the metal reagent can improve the diffusion of the fluid reagent into the metal reagent bed. This, in its turn, can enhance the wetting of the metal reagent with the fluid reagent, thus improving the reaction rate between the metal reagent and the fluid reagent.

The support element can comprise any material that is suitable for the desired application and that can withstand the conditions needed to achieve the desired result. For example, the support element can comprise a polymer that is able to substantially withstand exposure to the reaction conditions, such as elevated temperature and an acidic environment. In still further aspects, the support element can comprise a polymer that is capable of substantially withstanding exposure to an acidic environment and a temperature up to about 120° C. In still further aspects, the polymer can withstand the acidic environment and temperatures in a range from about 60° C. to about 120° C., including exemplary values of about 70° C., about 80° C., about 90° C., about 100° C., and about 110° C.

In still further aspects, the support element can comprise chlorinated polyvinyl chloride, fiberglass, PTFE, polycarbonate, polypropylene, or any combination thereof. In still further aspects, the support element can comprise other materials that are suitable for use in the desired application. In still further aspects, and as shown, for example, in FIGS. 2A-2F, the support element has a plurality of CPVC hollow pipes having, for example, a pipe diameter from about 2″ to about 12″, including exemplary values of about 3″, about 4″, about 5″, about 6″, about 7″, about 8″, about 9″, about 10″, and about 11″ and arranged such that a top portion of the support element is about 20″ to 36″, including exemplary values of about 21″, bout 22″, about 23″, about 245″, about 25″, about 26″, about 27″, about 28″, about 29″, about 30″, about 31″, about 32″, about 33″, about 34″, and about 35″ from a bottom portion of the reactor tank.

In still further aspects and as shown, for example, in FIGS. 2B-2E, the metal catalyst is substantially in contact with the support element. In such exemplary aspects, the metal catalyst present, for example, like a net, wool, a screen, foam, or any combination thereof, can be placed to substantially cover the support element. In yet other exemplary aspects, the metal catalyst can be placed such that it can at least partially enclose the metal reagent within the predetermined spaces defined by the support element pattern.

In still further aspects, the system can comprise an additional support member that is at least partially in substantial contact with the support element and the metal reagent. In such exemplary aspects, the additional support member can comprise an inert material and is configured to form at least a partial enclosure of the metal reagent on the support element. For example, as shown in FIG. 2F, an exemplary net comprising a material inert to the process conditions, can be positioned on the support element to form enclosures between the plurality of members of the support element. In some aspects, the inert material can comprise polypropylene, polyethylene, polyvinyl chloride, polyester, and the like. In some aspects, the inert material can be present in any configuration that would allow substantial contact between the support element and the metal catalyst. In some aspects, it can be configured as a net, a mesh, or film, or any other suitable form. The metal catalyst can then be disposed on the inert material. In some aspects, the additional support member can be used to immobilize the metal catalyst and the metal reagent.

In still further aspects, and as shown in FIG. 2F, at least a portion of the plurality of members can comprise a plurality of apertures having a diameter substantially lower than an average diameter of aluminum metal pellets. In such exemplary aspects, this plurality of apertures can assist in a substantial wetting of substantially all or at least a substantial portion of the metal bed with the fluid reagent. It is understood that in such aspects, the fluid reagent can enter the inner volume of the hollow members of the support element through these apertures and deliver the fluid reagent to various depths of the metal pellet bed. In still other aspects, the presence of the disclosed herein plurality of apertures can prevent the accumulation of various gases within the hollow pipes and substantially improve the safety of the process.

In yet further aspects, the system disclosed herein can further comprise at least one pumping member configured to pump the fluid reagent within at least a portion of the plurality of members of the support element such that the fluid reagent is dispensed from at least a portion of the plurality of apertures within the metal reagent bed. In such aspects, the pumping can allow an additional circulation of the fluid reagent within the metal reagent bed, thus improving diffusion of the reagent and enhancing the reaction rate.

It is understood that the systems disclosed herein can be commercially scaled by retrofitting existing reactor tanks. As disclosed herein, the support element can be modular so that tanks of different sizes can be easily accommodated by numbering up or down the number of modules. In such aspects, the use of the disclosed system can minimize tooling and fabrication costs. The exemplary isometric and top view schematic for the two modules are shown in FIGS. 4A-4B. In such exemplary and unlimiting aspects, each module can be composed of three sets of 6″ diameter horizontal pipes that form a fence (3′×2′) that impedes the movement of the pellet bed. Four posts can provide a rigid structure that holds the fence in place. Each exemplary pipe has apertures that can be about ⅛″ to about 1″ in diameter. This prevents any gases from becoming trapped inside the pipes.

The metal catalyst in the form of a screen can then be wrapped around the horizontal pipes. In certain aspects, the screen opening can be in the range of about ⅛″ to about 1/32″, including exemplary values of about 1/9″, about 1/10″, about 1/12″, and about 1/16″ to provide maximum surface area while preventing the pellets from entering the interior of the pipes. In certain exemplary aspects, the posts can be composed of pipes with a larger diameter than the horizontal pipes and are capped at the top to prevent pellets from entering the structure. In yet still further aspects, these posts can be used for pumping the fluid reagent through the pipes.

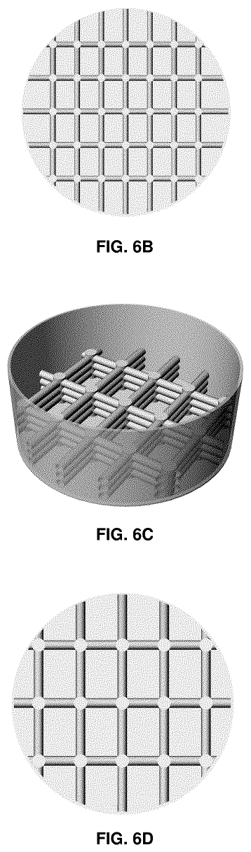

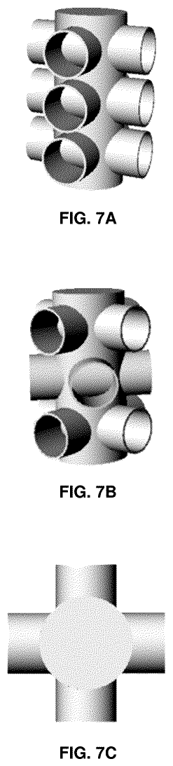

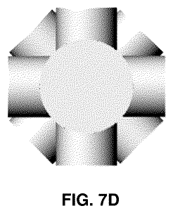

In certain aspects, the posts can be configured to connect the modules together, as shown, for example, in FIG. 5. In certain aspects, the posts can be composed of three four-way unions (FIGS. 7A-7D). In such exemplary aspects, each union can be independently rotated about the vertical axis. This allows for a variety of different module configurations. The exemplary and unlimiting configurations are shown in FIGS. 4A-4D. FIGS. 7A and 7C depict posts that can be used for the module shown in FIGS. 4A, 4C, while FIGS. 7B and 7D depict posts useful for the module shown in FIGS. 4B and 4D. In still further aspects, and as disclosed above, the modules can be assembled into patterns that are suitable for tanks with a circular diameter, as shown in FIGS. 6A-6D. It is understood that any number of modules can be used depending on the specific application. In some exemplary aspects, the number of modules can increase as the diameter of the tank increases, as, for example, shown in FIGS. 6B and 6D.

In certain aspects, the modules can also be positioned on top of an acid-resistant material to protect the bottom of the tank from abrasion due to the movement of the pellets inside the module. In such exemplary aspects, the acid-resistant material can be present as a film, a mat, a net, or any other configuration that would be desirable to the specific application. In yet still further aspects, the acid-resistant material can comprise one or more layers of acid-resistant compounds such as CPVC, fiberglass, PTFE, polycarbonate, polypropylene, and the like. In certain aspects, if the acid-resistant material is a net, a plurality of various nets can be staggered together to create openings of about ⅛″ or less. In yet still further aspects, a metal catalyst material can also optionally be placed on top of the acid-resistant material.

In still further aspects, the reaction product obtained by the use of the systems and methods disclosed herein comprises a reduced amount of metal contaminants when compared to a substantially identical reference system in the absence of the metal catalyst and the support element. In such exemplary aspects, the reaction product is substantially free of metal contaminations. In still further aspects, the reaction product has a turbidity of less than about 50, less than about 45, less than about 40, less than about 35, less than about 30, less than about 25, less than about 20, less than about 15, or less than about 10. Without wishing to be bound by any theory, it is suggested that higher purity of the product and low turbidity can be achieved by the use of the support element that allows a better wetting of the metal bed along with the use of the metal catalyst. The metal catalyst can also be chosen such that its redox potential has a value to allow selective oxidation of the metal reagent without causing oxidation of the possible impurities present in the metal reagent.

Also disclosed herein is the system comprising: a reactor tank configured to receive a fluid reagent and comprising: a support element configured to support a metal reagent disposed as a metal reagent bed, wherein the support element is configured to immobilize at least one portion of the metal reagent in a predetermined space, wherein the predetermined space is defined by a support element pattern, and wherein the support element is further configured to allow the fluid reagent to substantially wet at least a portion of the metal reagent.

In such systems, any of the disclosed above support elements can be present. In still further aspects, these exemplary systems can further comprise any of the disclosed above metal and fluid reagents. In still further aspects, these systems do not comprise a metal catalyst. While in other aspects, any of the disclosed above catalysts can also be present.

In still further aspects, these exemplary systems can also comprise an additional support member, as disclosed above.

### Methods

Also disclosed herein are methods of making aluminum chlorohydrates. In certain aspects, disclosed herein is a method comprising: contacting an aluminum feedstock with a fluid reagent comprising hydrochloric acid to form an aluminum chlorohydrate solution in the presence of a metal catalyst, wherein the metal catalyst is in substantial contact and electrical communication with at least a portion of the aluminum feedstock; wherein the step of contacting is in a reactor tank comprising a support element configured to support the aluminum feedstock disposed as an aluminum bed, wherein the support element is positioned such that the fluid reagent is configured to wet substantially all or at least a substantial portion of the aluminum bed.

Also disclosed are methods comprising contacting an aluminum feedstock with a fluid reagent comprising hydrochloric acid to form an aluminum chlorohydrate solution; wherein the step of contacting is in a reactor tank comprising a support element configured to support the aluminum feedstock disposed as an aluminum bed, wherein the support element is configured to immobilize at least one portion of the aluminum feedstock in a predetermined space, wherein the predetermined space is defined by a support element pattern, and wherein the support element is positioned such that the fluid reagent is configured to wet substantially all or at least a substantial portion of the aluminum bed.

It is understood that the aluminum feedstock used in these methods can comprise any of the disclosed above aluminum metal reagents, having any of the disclosed above purity levels. Any of the disclosed above fluid reagents can also be utilized. In still further aspects, any of the disclosed above support elements can be used.

In still further aspects, any of the disclosed above additional support members can also be used.

In still further aspects, in the methods where the metal catalyst is utilized, any of the disclosed above metal catalysts can be used.

In still further aspects, the fluid reagent can be added by any known in the art methods applicable to the specific application. In some aspects, the fluid reagent can be added to the reactor as a batch soliton. In yet other aspects, the fluid reagent can be pumped with the pumping member and circulated through the reactor as described above.

### EXAMPLES

The following examples are put forth so as to provide those of ordinary skill in the art with a complete disclosure and description of how the compounds, compositions, articles, devices, and/or methods claimed herein are made and evaluated and are intended to be purely exemplary and are not intended to limit the disclosure. Efforts have been made to ensure accuracy with respect to numbers (e.g., amounts, temperature, etc.), but some errors and deviations should be accounted for.

### Example 1

First, a grid or waffle-like structure (covered with polypropylene netting) was used to immobilize the pellet and minimize piling. A metallic screen, wool, or other high surface area form of the metal catalyst was used to catalyze the dissolution reaction, thus lowering the excess of aluminum needed to drive the reaction to completion in the desired time period. The metal catalyst was placed on the surface of the netting so as to maximize its contact with the pellet bed. In these conditions, an ACH synthesis can be accomplished in 24 h with a 120 to 150% charge of aluminum pellets having an average size of about ⅜″. Use of a smaller charge of aluminum results in a reduced pellet bed thickness, reduced process costs, and minimized waste in cleanout runs.

In conventional processes without the presence of the support element or the metal catalyst disclosed herein, to accomplish a reaction within 24 hours with aluminum pellets having an average size of about ⅜ inch pellet (P0610), a 200% pellet charge is required.

The systems and methods disclosed herein allow the production of ACH using a copper screen catalyst in 24 h using a 120-150% pellet charge, thereby reducing the bed height by 30-50% depending on the reactor dimensions.

As disclosed above, any of the metal catalysts having a redox potential more positive than a redox potential of the metal reagent can be utilized. However, the choice of the metal catalyst can also be based on economic benefits, safety concerns, metal catalyst stability, and the like. In some examples, the metal catalyst is copper. Yet, in other examples, the metal catalyst is nickel. It is also understood that while, in some examples, the metal catalyst is substantially resistant to the process conditions, it is contemplated that some dissolution of the metal catalyst can occur. While this dissolution is not expected to be significant, from an industry perspective, there are limitations on the amounts of dissolved metal catalysts present in the final product. For example, while nickel-metal can be used as an efficient metal catalyst, the maximum allowable concentration of nickel in the ACH solution is limited to 20 ppm to meet USP standards. Again, while a metal catalyst such as nickel is not expected to dissolve under the process conditions, one needs to be aware of the industry limitations on the amount of impurities in the ACH solutions and to choose the metal catalysts accordingly.

In examples where the metal catalyst is not substantially resistant to the process conditions, the use of such catalysts is still possible if this catalyst does not form toxic impurities and if there are no industry limitations on their presence. For example, iron metal catalysts can effectively catalyze the disclosed herein processes but are unstable to the highly acidic reaction conditions and corrode quickly. However, iron is not considered to be toxic and is not regulated by USP standards. Yet, in other examples, when for example, the ACH is designated for the cosmetic market, iron contaminant can be undesirable, and therefore copper can be used as a metal catalyst.

Referring to FIG. 2A, the support element shown in FIG. 2A is constructed of CPVC piping which can withstand the temperatures of the ACH reaction and the corrosion of the acid solution. This form was fitted with a copper screen (100 mesh), as shown in FIG. 2B and designed to fit snugly in the bottom of a tack reactor (FIG. 2C). The undulating (waffle) surface can hold the aluminum pellet in place, as shown in FIG. 2D, and thus, increase the copper-aluminum contact area. This design both minimizes the pellet piling effect during the reaction and maximizes the catalytic effect. FIG. 2E shows the catalyst system after an ACH production run with some of the pellets bones still observable. FIG. 2F shows a related design in which the CPVC pipes were perforated with numerous small apertures to allow free circulation of the acid solution through the pipes. This design allows the trapped hydrogen gas to escape. This configuration can be further modified by placing a polypropylene netting around the CPVC skeleton. This was done to provide mechanical support to the copper screen, which is placed over this netting in the final configuration.

Additional configuration of the use of a ‘star’ pipe copper screen catalyst is shown in FIG. 3. As can be seen in the middle portion of FIG. 3 using this configuration, a serious piling in the reactor was avoided. After three or four runs, the star catalyst pad collects some black iron deposits, which are not easily dislodged by simple rinsing/hosing. These deposits do not harm the catalyst's performance but can only be washed away by giving the whole catalyst a mild acid (acetic acid) soaking overnight.

### Example 2

A lab-scale ACH synthesis reaction using aluminum pellets was done according to the following procedures. A charge of the aluminum pellets (100 to 200 g) representing about 110% to about 200% of the desired stoichiometric amount was placed in a 1 L flask. Water and HCl were added, and once the vigorous H₂ evolving reaction settled enough, the flask was placed in an oil bath at 95° C. and fitted with a reflux condenser. Aliquots were withdrawn at various timepoints to determine the endpoint. The reaction was considered complete when the aluminum to chloride molar ratio was 1.91 (or greater) to 1. Additional water can be added or removed at this point such that the specific gravity of the solution is between 1.30 and 1.35. Aluminum % and chloride % were determined by standard titrations, and the final ACH product was measured for specific gravity (SG), pH, turbidity, and obviously %Al and %Cl. Specifications for ACH are given in Table 1.

TABLE 1
Specifications for ACH

| Test | Min | Max |
|---|---|---|
| % Aluminum by mass | 12.2 | 12.7 |
| % chloride by mass | 7.9 | 8.4 |
| Al/Cl ratio | 1.91 | 2.10 |
| SG | 1.330 | 1.350 |
| pH (30% solution) | 4.0 | 4.4 |
| Turbidity (NTUs) | 0 | 50 |

For a pilot-scale reaction, a 10-gallon polypropylene tank was equipped with a heater (encased in a copper pipe), circulation pump, and automatic water level maintainer and was customized such that the heater will shut off if the pump stopped working or the water level gets too low. The heater was regulated by a control system such that the temperature of the bath can be maintained at any set point. For the ACH synthesis, the temperature was set to 95° C. For a typical ⅜ inch aluminum pellet run, the tank was charged with 6.0 kg aluminum (5.0 kg would be stoichiometric), 6 gal water, and 7.82 L of concentrated HCl (37%) was added over a period of 3 h, during which the temperature increased from 25° C. to boiling. The heater was turned on once the bath started to cool below 95° C. If needed, the tank was wrapped with insulation to help it maintain a constant 95° C. temperature. When this reaction is complete, generally, 7.0 to 7.5 gallons of ACH are produced. Once the bones are accessible, they are rinsed and dried and weighed.

The experimental data contained in Table 2 summarizes a number of lab and pilot-scale reactions with and without a metal catalyst disclosed herein present. The Al:Cl ratio in the ACH was 1.9 to 2.1 Al to 1 Cl, which is indicative of a complete run. Runs 10-17 represent control reactions done at the lab or pilot scale. As seen in the control runs, the runs with lower purity aluminum are faster, similar to the runs with a greater stoichiometric excess or smaller pellet size (increase in surface area). Comparing run 14 with run 15, an increase in the aluminum pellet charge from 120% to 200% (⅜ in pellet, P0610) resulted in a decrease in reaction time from 73 to 25 h, nearly three times faster. In the presence of a copper screen catalyst and a 120% charge of ⅜inch Al 0610 pellets, it was taken 35 h to arrive at the completion of the reaction compared to 72 h without a catalyst. The run can be completed in 24 h with a 140% ⅜ inch pellet (0610) charge and the copper screen catalyst (Run 39).

Two larger-scale reactions in which a 120% charge of ⅜″ aluminum pellets (0610) at a larger scale (6 kg Al in a 10 gal reactor) took 36 h and 44 h to arrive at completion, respectively (Runs 40 and 41), which is similar to or slightly longer than the lab scale (200 g) Run 37 (35 h) under similar conditions, indicating that the exact catalytic enhancement can be dependent to some extent of the copper catalyst configuration. Better catalysis was observed with the copper waffle over the copper star configurations, which corresponds with the increase in the surface area of the former. Runs 21-27 using 140% to 150% charge and copper wool or screen catalyst are typically done in less than 30 h, regardless of the purity of the aluminum. When the charge is lowered to 110%, reaction times of 31 h or less were observed, even with high-purity aluminum (0303) pellet.

In certain aspects, the processes of forming polyaluminum chloride (PAC) solutions are also needed. PAC solutions are similar to ACH in composition and are also sold commercially for applications in which a different Al/Cl is desired, as well as a lower pH. Typical PACs range from an Al/Cl ratio of 0.3 to 1.5. For reference, the ACH Al/Cl ratio is 1.9-2.1, which is the largest ratio this ratio can be without precipitation of Al(OH)₃. The lower the Al/Cl ratio, the greater the acidity of the solution. For example, the pH of ACH is ˜4.2, whereas the commercially available PAC, known as, for example, PAX18, has a pH of 0.9 and an Al/Cl ratio of 0.57. As the preparation of PAC can often be achieved directly from Al₂O₃ and HCl or AlCl₃ and water, it is generally cheaper to produce than ACH. In certain instances, it may be desired to upgrade a PAC to form ACH, as less aluminum metal is required for the overall process. In such a case, the PAC acts as the acid, and the dissolution of the aluminum increases the Al/Cl ratio. Run 28 shows that PAC commercially sold under the name of PAX18 can be upgraded to ACH in ˜30 h, which may be useful in some circumstances.

Runs 42-45 used nickel-metal catalysts and aluminum pellets at a 110% charge. ACH was produced in 24 h or less, and only 2 ppm≤trace Ni was found in the product, except when Ni powder was used instead of a monolith (wire, screen, foam). Notably, a number of ingot runs could be completed even with a low charge (110 or 200%) using copper screen/wool or nickel foam. (Runs 34, 35, 46, 47)

As can be seen in FIGS. 2D and 2E, the catalyst form helps immobilize the pellets to prevent piling during the reaction, thereby minimizing the risk of a really deep aluminum pellet pile forming during the reaction. No piling effects were observed in any run in which the waffle frame was present, regardless of whether the copper screen was present or not. This latter result shows the waffle design, even if not covered with a catalytic metal, can be useful in mitigating bed piling.

FIG. 2E shows another design in which the CPVC support is augmented with a polypropylene mesh before the copper screen is added. This polypropylene mesh acts as an additional mechanical support for the catalyst material. It was observed that the copper screen walls in FIG. 2B can be pushed together to touch the adjacent copper screen ‘wall’ in the absence of additional mechanical support. This extra mechanical support, therefore, helps to optimize the diffusion between the anodic and cathodic sites and, thus, the catalytic rate.

TABLE 2
Reaction parameters for ACH synthesis in the presence and absence of heterogeneous catalysts.

| | Aluminum | Charge | Heterogeneous | Duration | | | | Fe | Cu | Ni |
|---|---|---|---|---|---|---|---|---|---|---|
| Run | Feedstock | (%, g) | catalyst | time (h) | | SG | Yield | (ppm) | (ppm) | (ppm) |
| 10 | 150% 5N | 150 | none | 138 | h | 1.33 | 94% | 2 | 0 | 0 |
| | pellet(⅜″) | | | | | | | | | |
| 11 | 110% 0303 | 110 | none | 68 | h | 1.34 | 87% | 58 | 0 | 0 |
| | pellet(⅜″) | | | | | | | | | |
| 12 | 110% 1535 | 110 | none | 16 | h | 1.34 | 96% | 181 | 0 | 0 |
| | pellet(⅜″) | | | | | | | | | |
| 13 | 150% 0610 | 150 | none | 21 | h | 1.33 | | 85 | 0 | 0 |
| | pellet(¼″) | | | | | | | | | |
| 14 | 120% 0610 pellet | 120%, | none | 73 | h | 1.34 | 101% | | | |
| | (⅜″) | 200 g | | | | | | | | |
| 15 | 200% 0610 pellet | 200%, | none | 25 | h | 1.36 | 105% | | | |
| | (⅜″) | 300 g | | | | | | | | |
| 16 | 0610 ingot | 200%, | none | 102 | h | 1.34 | | | | |
| | | 446 g | | | | | | | | |
| 17 | 0610 ingot | 200%, | none | 91 | h | 1.35 | 100% | 17 | 20 | 0 |
| | | 10 kg | | | | | | | | |
| 20 | 150% 4N pellet | 150%, | Cu screen (100 | 54 | h | 1.33 | 85% | 3 | 0 | 0 |
| | (⅜″) | 220 g | mesh) 11.5 g | | | | | | | |
| 21 | 150% 4N pellet | 150%, | Cu screen (100 | 32 | h | 1.33 | 91% | 3 | 0 | 0 |
| | (⅜″) | 220 g | mesh) 28.5 g | | | | | | | |
| 22 | 150% 4N pellet | 150%, | Cu screen (100 | 27 | h | 1.33 | 89% | 2 | 0 | 0 |
| | (⅜″) | 220 g | mesh) 28.5 g + | | | | | | | |
| | | | 82 g bones | | | | | | | |
| 23 | 150% 4N pellet | 150%, | Cu wool 12.8 g | 24 | h | 1.33 | 95% | 2 | 0 | 0 |
| | (⅜″) | 220 g | | | | | | | | |
| 24 | 150% 0303 pellet | 150%, | Cu wool 12.8 g | 23 | h | 1.34 | 94% | 17 | 0 | 0 |
| | (⅜″) | 220 g | | | | | | | | |
| 25 | 150% 5N | 150%, | Cu wool 12.8 g | 25 | h | 1.33 | 97% | 2 | 0 | 0 |
| | pellet(⅜″) | 220 g | | | | | | | | |
| 27 | 150% 0610 pellet | 150%, | Cu wool 13 g | 15 | h | 1.33 | 100% | 43 | 0 | 0 |
| | (¼″) | 220 g | | | | | | | | |
| 28 | 110% 0303 | 110%, | Cu wool 12.8 g | 30 | h | 1.33 | 86% | 68 | 2 | 0 |
| | pellet(⅜″)/PAX18 | 113 g | | | | | | | | |
| 29 | 110% 1535 | 110%, | Cu wool 12.8 g | 11 | h | 1.36 | 104% | | | |
| | pellet(⅜″) | 113 g | | | | | | | | |
| 30 | 110% 1535 | 110%, | Cu wool 12.8 g | 7.5 | h | 1.33 | 87% | 120 | 0 | 0 |
| | pellet(⅜″) | 113 g | | | | | | | | |
| 31 | 110% 0303 | 110%, | Cu screen (20 | 27 | h | 1.33 | | 11 | 6 | 0 |
| | pellet(⅜″) | 113 g | mesh) + Ni wire | | | | | | | |
| 32 | 110% 0303 | 110%, | Cu screen (20 | 31 | h | 1.35 | 93% | | | |
| | pellet(⅜″) | 113 g | mesh) + Ni wire | | | | | | | |
| 34 | 110% 0406 ingot | 110 | Cu screen | 61 | h | 1.33 | 85% | 70 | 0 | 0 |
| | | | (100mesh) | | | | | | | |
| 35 | 110% 0406 ingot | 110 | Cu wool | 48 | h | 1.32 | 94% | 70 | 0.5 | 0 |
| 36 | 110% 0610 ingot | 110 | Cu screen | 42 | h | 1.32 | 97% | 61 | 0 | 0 |
| | | | (100mesh) | | | | | | | |
| 37 | 120% 0610 pellet | 120%, | Cu screen 18 g | 35 | h | 1.34 | 98% | — | — | — |
| | (⅜″) | 200 g | (100 mesh) | | | | | | | |
| 38 | 130% 0610 pellet | 130%, | Cu screen 18 g | 29 | h | 1.34 | 98% | — | — | — |
| | (⅜″) | 200 g | (100 mesh) | | | | | | | |
| 39 | 140% 0610 pellet | 140%, | Cu screen 18 g | 24 | h | 1.34 | 98% | — | — | — |
| | (⅜″) | 200 g | (100 mesh) | | | | | | | |
| 40 | 120% 0610 pellet | 120%, | Cu waffle | 36 | h | 1.36 | 100% | 40 | 6 | 0 |
| | (⅜″) | 6.0 kg | | | | | | | | |
| 41 | 120% 0610 pellet | 120%, | Cu ‘Star’ screen | 44 | h | 1.36 | 100% | 53 | 4 | 0 |
| | (⅜″) | 6.0 kg | | | | | | | | |
| 42 | 110% 0610 pellet | 110 | Ni foam 2.6 g | 22 | h | 1.32 | 76% | 80 | 0 | 0 |
| | (¼″) | | | | | | | | | |
| 43 | 110% 0303 pellet | 110 | Ni foam 7.5 g | 22 | h | 1.34 | 94% | 22 | 0 | 2 |
| | (⅜″) | | | | | | | | | |
| 45 | 110% 0303 pellet | 110 | Ni powder(size 2- | 23 | h | 1.34 | 93% | 57 | 0 | 96 |
| | (⅜″) | | 3 um) 0.1 g | | | | | | | |
| 46 | 200% 0610 ingot | 200 | Ni monel screen | 49 | h | 1.34 | 95% | 39 | 0 | 0 |
| 47 | 200% 0610 ingot | 200 | Ni monel screen | 47 | h | 1.34 | 86% | 54 | 0 | 0 |
| | | | (acid washed) | | | | | | | |

The claims are not intended to include, and should not be interpreted to include, means-plus- or step-plus-function limitations unless such a limitation is explicitly recited in a given claim using the phrase(s) “means for” or “step for,” respectively.

In view of the described processes and compositions, hereinbelow are described certain more particularly described aspects of the inventions. These particularly recited aspects should not, however, be interpreted to have any limiting effect on any different claims containing different or more general teachings described herein or that the “particular” aspects are somehow limited in some way other than the inherent meanings of the language and formulas literally used therein.

### Aspects:

Aspect 1: A system comprising: a) a reactor tank configured to receive a fluid reagent and comprising: a support element configured to support a metal reagent disposed as a metal reagent bed; wherein the support element is further configured to allow the fluid reagent to substantially wet at least a portion of the metal reagent, and b) a metal catalyst.

Aspect 2: The system of Aspect 1, wherein the support element is further configured to partition at least one portion of the metal reagent from a remaining portion of the metal reagent.

Aspect 3: The system of Aspect 1 or 2, wherein the support element is further configured to immobilize at least one portion of the metal reagent in a predetermined space, wherein the predetermined space is defined by a support element pattern.

Aspect 4: The system of any one of Aspects 1-3, wherein at least a portion of the support element is inseparably coupled to at least a portion of the reactor tank.

Aspect 5: The system of any one of Aspects 1-4, wherein at least a portion of the support element is separately coupled with at least a portion of the reactor tank.

Aspect 6: The system of any one of Aspects 1-3, wherein the support element is not physically coupled to the reactor tank.

Aspect 7: The system of any one of Aspects 1-6, wherein the system further comprises the metal reagent.

Aspect 8: The system of any one of Aspects 1-7, wherein the system further comprises the fluid reagent.

Aspect 9: The system of any one of Aspects 1-8, wherein the metal reagent comprises aluminum metal pellets.

Aspect 10: The system of any one of Aspects 1-9, wherein the fluid reagent is in fluid communication with substantially all or at least a substantial portion of the metal reagent bed.

Aspect 11: The system of any one of Aspects 1-10, wherein the fluid reagent comprises an aqueous hydrochloric acid.

Aspect 12: The system of any one of Aspects 1-11, wherein a reaction product between the metal reagent and the fluid reagent comprises aluminum chlorohydrate.

Aspect 13: The system of Aspect 12, wherein the support element comprises a plurality of members forming the support element pattern.

Aspect 14: The system of Aspect 13, wherein the support element pattern is effective to reduce a height of the metal reagent bed and decrease in turbidity in the reaction product when compared to a substantially identical reference system in the absence of the support element and the metal catalyst.

Aspect 15: The system of Aspect 14, wherein the support element pattern comprises a waffle pattern, a star pattern, a grid pattern, or a combination thereof.

Aspect 16: The system of any one of Aspects 13-15, wherein the plurality of members are arranged into a plurality of modules configured to form one or more of the support element patterns.

Aspect 17: The system of any one of Aspects 1-16, wherein the support element comprises a polymer configured to substantially withstand exposure to an acidic environment and a temperature up to 120° C.

Aspect 18: The system of any one of Aspects 13-17, wherein at least a portion of the plurality of members comprises a plurality of apertures having a diameter substantially lower than an average diameter of aluminum metal pellets.

Aspect 19: The system of Aspect 18, wherein the plurality of apertures assist in a substantial wetting of substantially all or at least a substantial portion of the metal bed with the fluid reagent.

Aspect 20: The system of Aspect 18 or 17, wherein the system further comprises at least one pumping member configured to pump the fluid reagent within at least a portion of the plurality of members of the support element such that the fluid reagent is dispensed from at least a portion of the plurality of apertures within the metal reagent.

Aspect 21: The system of Aspect 20, wherein the fluid reagent is at least partially circulated within the metal reagent.

Aspect 22: The system of any one of Aspects 1-21, wherein the metal catalyst comprises a metal net, a wool, a screen, immobilized nanoparticles, a foam, or any combination thereof.

Aspect 23: The system of any one of Aspects 1-22, wherein the metal catalyst has a redox potential effective to induce oxidation of the metal reagent.

Aspect 24: The system of any one of Aspects 1-23, wherein the metal catalyst comprises iron, nickel, zinc, silver, cobalt, copper, palladium, ruthenium, iridium, platinum, gold, alloys thereof, or any combination thereof.

Aspect 25: The system of any one of Aspects 1-24, wherein the metal catalyst is in substantial contact and electrical communication with at least a portion of the metal reagent bed.

Aspect 26: The system of any one of Aspects 1-25, wherein at least a portion of the metal catalyst is in substantial contact with at least a portion of the support element.

Aspect 27: The system of any one of Aspects 1-27, wherein the system further comprises an additional support member that is at least partially in substantial contact with the support element and the metal reagent.

Aspect 28: The system of Aspect 28, wherein the additional support member comprises an inert material and is configured to form at least a partial enclosure of the metal reagent on the support element.

Aspect 29: The system of any one of Aspects 1-28, wherein the metal reagent bed has a height from at least 10% lower when compared to a height of a metal reagent bed of a substantially identical reference system in the absence of the metal catalyst and the support element.

Aspect 30: The system of any one of Aspects 1-29, wherein the metal reagent and the fluid reagents are present in a ratio from about 2:1 to about 10:1.

Aspect 31: The system of any one of Aspects 12-30, wherein the metal reagent is present in an amount at least 20% lower when compared to a substantially identical reference system in the absence of the metal catalyst and the support element while forming the reaction product with a yield substantially identical to the substantially identical reference system in the absence of the metal catalyst and the support element.

Aspect 32: The system of Aspect 31, wherein the reaction product yield is greater than about 85%.

Aspect 33: The system of Aspect 31 or 32, wherein the yield is obtained in a time period that is at least about 30% shorter than a time needed to achieve a substantially identical yield in the substantially identical reference system in the absence of the metal catalyst and the support element.

Aspect 34: The system of any one of Aspects 12-33, wherein the reaction product comprises a reduced amount of metal contaminants when compared to a substantially identical reference system in the absence of the metal catalyst and the support element.

Aspect 35: The system of any one of Aspects 12-34, wherein the reaction product is substantially free of metal contaminations.

Aspect 36: The system of any one of Aspects 12-35, wherein the reaction product has a turbidity of less than about 50.

Aspect 37: A method comprising: contacting an aluminum feedstock with a fluid reagent comprising hydrochloric acid to form an aluminum chlorohydrate solution in the presence of a metal catalyst, wherein the metal catalyst is in substantial contact and electrical communication with at least a portion of the aluminum feedstock; wherein the step of contacting is in a reactor tank comprising a support element configured to support the aluminum feedstock disposed as an aluminum bed, wherein the support element is positioned such that the fluid reagent is configured to wet substantially all or at least a substantial portion of the aluminum bed.

Aspect 38: The method of Aspect 37, wherein the support element is further configured to partition at least one portion of the metal reagent from a remaining portion of the metal reagent.

Aspect 39: The method of Aspect 37 or 38, wherein the support element is further configured to immobilize at least one portion of the metal reagent in a predetermined space, wherein the predetermined space is defined by a support element pattern.

Aspect 40: The method of any one of Aspects 37-39, wherein at least a portion of the support element is inseparably coupled to at least a portion of the reactor tank.

Aspect 41: The method of any one of Aspects 37-40, wherein at least a portion of the support element is separately coupled with at least a portion of the reactor tank.

Aspect 42: The method of any one of Aspects 37-41, wherein the support element is not physically coupled to the reactor tank.

Aspect 43: The method of any one of Aspects 37-42, wherein the aluminum feedstock comprises aluminum metal pellets.

Aspect 44: The method of any one of Aspects 37-43, wherein the support element comprises a plurality of members forming the support element pattern.

Aspect 45: The method of Aspect 44, wherein the support element pattern is effective to reduce a height of the aluminum bed and decrease in turbidity in the aluminum chlorohydrate solution when compared to a substantially identical reference method in the absence of the support element and the metal catalyst.

Aspect 46: The method of Aspect 44 or 45, wherein the support element pattern comprises a waffle pattern, a star pattern, a grid pattern, or a combination thereof.

Aspect 47: The method of any one of Aspects 44-46, wherein the plurality of members are arranged into a plurality of modules configured to form one or more of the support element patterns.

Aspect 48: The method of any one of Aspects 37-47, wherein the support element comprises a polymer configured to substantially withstand exposure to an acidic environment and a temperature up to 120° C.

Aspect 49: The method of any one of Aspects 37-48, wherein at least a portion of the plurality of members comprises a plurality of apertures having a diameter substantially lower than an average diameter of small aluminum metal pellets.

Aspect 50: The method of Aspect 49, wherein the plurality of apertures assist in a substantial wetting of substantially all or at least a substantial portion of the aluminum bed with the fluid reagent.

Aspect 51: The method of Aspect 49 or 50, wherein the method further comprises pumping the fluid reagent into at least a portion of the plurality of members of the support element such that the fluid reagent is dispensed from at least a portion of the plurality of apertures within the metal reagent.

Aspect 52: The method of Aspect 51, wherein the fluid reagent is at least partially circulated within the metal reagent.

Aspect 53: The metal of any one of Aspects 47-52, wherein the metal catalyst comprises a metal net, a wool, a screen, immobilized nanoparticles, a foam a, or any combination thereof.

Aspect 54: The method of any one of Aspects 37-53, wherein the metal catalyst comprises iron, nickel, zinc, silver, cobalt, copper, palladium, ruthenium, iridium, platinum, gold, alloys thereof, or any combination thereof.

Aspect 55: The method of any one of Aspects 37-54, wherein at least a portion of the metal catalyst is in substantial contact with at least a portion of the support element.

Aspect 56: The method of any one of Aspects 37-55, wherein the reactor further comprises an additional support member that is at least partially in substantial contact with the support element and the metal reagent.

Aspect 57: The method of Aspect 56, wherein the additional support member comprises an inert material and is configured to form at least a partial enclosure of the aluminum feedstock on the support element.

Aspect 58: The method of any one of Aspects 37-57, wherein the metal reagent bed has a height from at least 10% lower when compared to a height of a metal reagent bed of a substantially identical reference system in the absence of the metal catalyst and the support element.

Aspect 59: The method of any one of Aspects 37-58, wherein the aluminum feedstock and the fluid reagents are present in a ratio from about 2:1 to about 10:1.

Aspect 60: The method of any one of Aspects 37-59, wherein the aluminum feedstock is present in an amount at least 20% lower when compared to a substantially identical reference method in the absence of the metal catalyst and the support element while forming the reaction product with a yield substantially identical obtained in the substantially identical method in the absence of the metal catalyst and the support element.

Aspect 61: The method of Aspect 60, wherein the reaction product yield is greater than about 85%.

Aspect 62: The method of Aspect 60 or 61, wherein the yield is obtained in a time period that is at least about 30% shorter than a time needed to achieve a substantially identical yield in the substantially identical reference method in the absence of the metal catalyst and the support element.

Aspect 63: The method of any one of Aspects 37-62, wherein the reaction product comprises a reduced amount of metal contaminants when compared to a substantially identical reference method in the absence of the metal catalyst and the support element.

Aspect 64: The method of any one of Aspects 37-63, wherein the reaction product is substantially free of metal contaminations.

Aspect 65: The method of any one of Aspects 37-64, wherein the reaction product has a turbidity of less than about 50.

Aspect 66: A system comprising: a) a reactor tank configured to receive a fluid reagent and comprising: a support element configured to support a metal reagent disposed as a metal reagent bed, wherein the support element is configured to immobilize at least one portion of the metal reagent in a predetermined space, wherein the predetermined space is defined by a support element pattern, and wherein the support element is further configured to allow the fluid reagent to substantially wet at least a portion of the metal reagent.

Aspect 67: The system of Aspect 66, wherein the support element is further configured to partition at least one portion of the metal reagent from a remaining portion of the metal reagent.

Aspect 68: The system of any one of Aspects 66-67, wherein at least a portion of the support element is inseparably coupled to at least a portion of the reactor tank.

Aspect 69: The system of any one of Aspects 66-68, wherein at least a portion of the support element is separately coupled with at least a portion of the reactor tank.

Aspect 70: The system of any one of Aspects 66-69, wherein the support element is not physically coupled to the reactor tank.

Aspect 71: The system of any one of Aspects 66-70, wherein the system further comprises the metal reagent.

Aspect 72: The system of any one of Aspects 66-71, wherein the system further comprises the fluid reagent.

Aspect 73: The system of any one of Aspects 66-72, wherein the metal reagent comprises aluminum metal pellets.

Aspect 74: The system of any one of Aspects 66-73, wherein the fluid reagent is in fluid communication with substantially all or at least a substantial portion of the metal reagent bed.

Aspect 75: The system of any one of Aspects 66-74, wherein the fluid reagent comprises an aqueous hydrochloric acid.

Aspect 76: The system of any one of Aspects 66-75 wherein a reaction product between the metal reagent and the fluid reagent comprises aluminum chlorohydrate.

Aspect 77: The system of Aspect 76, wherein the support element comprises a plurality of members forming the support element pattern.

Aspect 78: The system of Aspect 77, wherein the support element pattern comprises a waffle pattern, a star pattern, a grid pattern, or a combination thereof.

Aspect 79: The system of any one of Aspects 77-78, wherein the plurality of members are arranged into a plurality of modules configured to form one or more of the support element patterns.

Aspect 80: The system of any one of Aspects 66-79, wherein the support element comprises a polymer configured to substantially withstand exposure to an acidic environment and a temperature up to 120° C.

Aspect 81: The system of any one of Aspects 77-80, wherein at least a portion of the plurality of members comprises a plurality of apertures having a diameter substantially lower than an average diameter of aluminum metal pellets.

Aspect 82: The system of Aspect 81, wherein the plurality of apertures assist in a substantial wetting of substantially all or at least a substantial portion of the metal bed with the fluid reagent.

Aspect 83: The system of Aspect 81 or 82, wherein the system further comprises at least one pumping member configured to pump the fluid reagent within at least a portion of the plurality of members of the support element such that the fluid reagent is dispensed from at least a portion of the plurality of apertures within the metal reagent.

Aspect 84: The system of Aspect 83, wherein the fluid reagent is at least partially circulated within the metal reagent.

Aspect 85: The system of any one of Aspects 66-84, further comprising a metal catalyst capable of catalyzing a reaction between the metal reagent and the fluid reagent.

Aspect 86: The system of Aspect 85, wherein the metal catalyst comprises a metal net, a wool, a screen, immobilized nanoparticles, a foam, or any combination thereof.

Aspect 87: The system of any one of Aspects 85-86, wherein the metal catalyst has a redox potential effective to induce oxidation of the metal reagent.

Aspect 88: The system of any one of Aspects 85-87, wherein the metal catalyst comprises iron, nickel, zinc, silver, cobalt, copper, palladium, ruthenium, iridium, platinum, gold, alloys thereof, or any combination thereof.

Aspect 89: The system of any one of Aspects 85-88, wherein the metal catalyst is in substantial contact and electrical communication with at least a portion of the metal reagent bed.

Aspect 90: The system of any one of Aspects 85-89, wherein at least a portion of the metal catalyst is in substantial contact with at least a portion of the support element.

Aspect 91: The system of any one of Aspects 66-90, wherein the system further comprises an additional support member that is at least partially in substantial contact with the support element.

Aspect 92: The system of Aspect 91, wherein the additional support member comprises an inert material and is configured to form at least a partial enclosure of the metal reagent on the support element.

Aspect 93: The system of any one of Aspects 66-92, wherein the metal reagent bed has a height from at least 5% lower when compared to a height of a metal reagent bed of a substantially identical reference system in the absence of the support element.

Aspect 94: The system of any one of Aspects 66-93, wherein the metal reagent and the fluid reagents are present in a ratio from about 2:1 to about 10:1.

Aspect 95: The system of any one of Aspects 85-94, wherein the metal reagent is present in an amount at least 20% lower when compared to a substantially identical reference system in the absence of the metal catalyst and the support element while forming the reaction product with a yield substantially identical to the substantially identical reference system in the absence of the metal catalyst and the support element.

Aspect 96: The system of Aspect 95, wherein the reaction product yield is greater than about 85%.

Aspect 97: The system of Aspect 95 or 96, wherein the yield is obtained in a time period that is at least about 30% shorter than a time needed to achieve a substantially identical yield in the substantially identical reference system in the absence of the metal catalyst and the support element.

Aspect 98: The system of any one of Aspects 76-97, wherein the reaction product comprises a reduced amount of metal contaminants when compared to a substantially identical reference system in the absence of the metal catalyst and the support element.

Aspect 99: The system of any one of Aspects 76-98, wherein the reaction product is substantially free of metal contaminations.

Aspect 100: The system of any one of Aspects 76-99, wherein the reaction product has a turbidity of less than about 50.

Aspect 101: A method comprising: contacting an aluminum feedstock with a fluid reagent comprising hydrochloric acid to form an aluminum chlorohydrate solution; wherein the step of contacting is in a reactor tank comprising a support element configured to support the aluminum feedstock disposed as an aluminum bed, wherein the support element is configured to immobilize at least one portion of the aluminum feedstock in a predetermined space, wherein the predetermined space is defined by a support element pattern, and wherein the support element is positioned such that the fluid reagent is configured to wet substantially all or at least a substantial portion of the aluminum bed.

Aspect 102: The method of Aspect 101, wherein the support element is further configured to partition at least one portion of the metal reagent from a remaining portion of the metal reagent.

Aspect 103: The method of any one of Aspects 101-102, wherein at least a portion of the support element is inseparably coupled to at least a portion of the reactor tank.

Aspect 104: The method of any one of Aspects 101-103, wherein at least a portion of the support element is separately coupled with at least a portion of the reactor tank.

Aspect 105: The method of any one of Aspects 101-104, wherein the support element is not physically coupled to the reactor tank.

Aspect 106: The method of any one of Aspects 101-105, wherein the aluminum feedstock comprises aluminum metal pellets.

Aspect 107: The method of any one of Aspects 101-106, wherein the support element comprises a plurality of members forming the support element pattern.

Aspect 108: The method of Aspect 107, wherein the support element pattern is effective to reduce a height of the aluminum bed and decrease in turbidity in the aluminum chlorohydrate solution when compared to a substantially identical reference method in the absence of the support element and the metal catalyst.

Aspect 109: The method of Aspect 107 or 108, wherein the support element pattern comprises a waffle pattern, a star pattern, a grid pattern, or a combination thereof.

Aspect 110: The method of any one of Aspects 107-109, wherein the plurality of members are arranged into a plurality of modules configured to form one or more of the support element patterns.

Aspect 111: The method of any one of Aspects 101-110, wherein the support element comprises a polymer configured to substantially withstand exposure to an acidic environment and a temperature up to 120° C.

Aspect 112: The method of any one of Aspects 101-111, wherein at least a portion of the plurality of members comprises a plurality of apertures having a diameter substantially lower than an average diameter of small aluminum metal pellets.

Aspect 113: The method of Aspect 112, wherein the plurality of apertures assist in a substantial wetting of substantially all or at least a substantial portion of the aluminum bed with the fluid reagent.

Aspect 114: The method of Aspect 112 or 113, wherein the method further comprises pumping the fluid reagent into at least a portion of the plurality of members of the support element such that the fluid reagent is dispensed from at least a portion of the plurality of apertures within the metal reagent.

Aspect 115: The method of Aspect 114, wherein the fluid reagent is at least partially circulated within the metal reagent.

Aspect 116: The method of any one of Aspects 101-115, wherein the method further comprises contacting the metal reagent with a metal catalyst, wherein the metal catalyst is capable of catalyzing a reaction between the metal reagent and the fluid reagent.

Aspect 117: The metal of Aspect 116, wherein the metal catalyst comprises a metal net, a wool, a screen, immobilized nanoparticles, a foam, or any combination thereof.

Aspect 118: The method of any one of Aspects 116-117, wherein the metal catalyst comprises iron, nickel, zinc, silver, cobalt, copper, palladium, ruthenium, iridium, platinum, gold, alloys thereof, or any combination thereof.

Aspect 119: The method of any one of Aspects 116-118, wherein at least a portion of the metal catalyst is in substantial contact with at least a portion of the support element.

Aspect 120: The method of any one of Aspects 101-119, wherein the reactor further comprises an additional support member that is at least partially in substantial contact with the support element and the metal reagent.

Aspect 121: The method of Aspect 120, wherein the additional support member comprises an inert material and is configured to form at least a partial enclosure of the aluminum feedstock on the support element.

Aspect 122: The method of any one of Aspects 101-121, wherein the metal reagent bed has a height from at least 5% lower when compared to a height of a metal reagent bed of a substantially identical reference system in the absence of the support element.

Aspect 123: The method of any one of Aspects 101-122, wherein the aluminum feedstock and the fluid reagents are present in a ratio from about 2:1 to about 10:1.

Aspect 124: The method of any one of Aspects 116-123, wherein the aluminum feedstock is present in an amount at least 20% lower when compared to a substantially identical reference method in the absence of the metal catalyst and the support element while forming the reaction product with a yield substantially identical obtained in the substantially identical method in the absence of the metal catalyst and the support element.

Aspect 125: The method of Aspect 124, wherein the reaction product yield is greater than about 85%.

Aspect 126: The method of Aspect 124 or 125, wherein the yield is obtained in a time period that is at least about 30% shorter than a time needed to achieve a substantially identical yield in the substantially identical reference method in the absence of the metal catalyst and the support element.

Aspect 127: The method of any one of Aspects 124-126, wherein the reaction product comprises a reduced amount of metal contaminants when compared to a substantially identical reference method in the absence of the metal catalyst and the support element.

Aspect 128: The method of any one of Aspects 124-127, wherein the reaction product is substantially free of metal contaminations.

Aspect 129: The method of any one of Aspects 101-128, wherein the reaction product has a turbidity of less than about 50.

What is claimed is:

1. A system comprising:
a) a reactor tank configured to receive a fluid reagent and comprising:
a support element configured to support a metal reagent disposed as a metal reagent bed;
wherein the support element is further configured to allow the fluid reagent to substantially wet at least a portion of the metal reagent; and
b) a metal catalyst.

2. The system of claim 1, wherein the support element is further configured:
to partition at least one portion of the metal reagent from a remaining portion of the metal reagent; and/or
to immobilize at least one portion of the metal reagent in a predetermined space, wherein the predetermined space is defined by a support element pattern.

3. The system of claim 1, wherein the system further comprises the metal reagent, the fluid reagent, or a combination thereof.

4. The system of claim 1, wherein the metal reagent comprises aluminum metal pellets.

5. The system of claim 1, wherein the fluid reagent comprises an aqueous hydrochloric acid.

6. The system of claim 1, wherein a reaction product between the metal reagent and the fluid reagent comprises aluminum chlorohydrate.

7. The system of claim 1, wherein the support element comprises a plurality of members forming a support element pattern and wherein the support element pattern comprises a waffle pattern, a star pattern, a grid pattern, or a combination thereof.

8. The system of claim 1, wherein the support element comprises a polymer configured to substantially withstand exposure to an acidic environment and a temperature up to 120° C.

9. The system of claim 7, wherein at least a portion of the plurality of members comprises a plurality of apertures having a diameter substantially lower than an average diameter of aluminum metal pellets.

10. The system of claim 9, wherein the system further comprises at least one pumping member configured to pump the fluid reagent within at least a portion of the plurality of members of the support element such that the fluid reagent is dispensed from at least a portion of the plurality of apertures within the metal reagent.

11. The system of claim 1, wherein the metal catalyst comprises a metal net, a wool, a screen, immobilized nanoparticles, a foam, or any combination thereof.

12. The system of claim 1, wherein the metal catalyst comprises iron, nickel, zinc, silver, cobalt, copper, palladium, ruthenium, iridium, platinum, gold, alloys thereof, or any combination thereof.

13. The system of claim 1, wherein the system further comprises an additional support member that is at least partially in substantial contact with the support element and the metal reagent, and wherein the additional support member comprises an inert material and is configured to form at least a partial enclosure of the metal reagent on the support element.

14. The system of claim 3, wherein the metal reagent and the fluid reagent are present in a ratio from about 2:1 to about 10:1.

15. The system of claim 6, wherein the reaction product is substantially free of metal contaminations.

16. The system of claim 6, wherein the reaction product has a turbidity of less than about 50.

17. A method comprising:
contacting an aluminum feedstock with a fluid reagent comprising hydrochloric acid to form an aluminum chlorohydrate solution in the presence of a metal catalyst, wherein the metal catalyst is in substantial contact and electrical communication with at least a portion of the aluminum feedstock; and
wherein the step of contacting is in a reactor tank comprising a support element configured to support the aluminum feedstock disposed as an aluminum bed, wherein the support element is positioned such that the fluid reagent is configured to wet substantially all or at least a substantial portion of the aluminum bed.

18. A system comprising:
a reactor tank configured to receive a fluid reagent and comprising a support element configured to support a metal reagent disposed as a metal reagent bed, wherein the support element is configured to immobilize at least one portion of the metal reagent in a predetermined space, wherein the predetermined space is defined by a support element pattern, and wherein the support element is further configured to allow the fluid reagent to substantially wet at least a portion of the metal reagent.

19. A method comprising:
contacting an aluminum feedstock with a fluid reagent comprising hydrochloric acid to form an aluminum chlorohydrate solution; and
wherein the step of contacting is in a reactor tank comprising a support element configured to support the aluminum feedstock disposed as an aluminum bed, wherein the support element is configured to immobilize at least one portion of the aluminum feedstock in a predetermined space, wherein the predetermined space is defined by a support element pattern, and wherein the support element is positioned such that the fluid reagent is configured to wet substantially all or at least a substantial portion of the aluminum bed.
